(19) United States
(12) Patent Application Publication
(10) Pub. No.: US 2014/0062389 A1
(43) Pub. Date: Mar. 6, 2014

(54) POWER GENERATOR, SECONDARY CELL, ELECTRONIC APPARATUS, AND TRANSPORTER

(71) Applicant: SEIKO EPSON CORPORATION, Tokyo (JP)

(72) Inventors: Noritaka IDE, Shiojiri-shi (JP); Kunio TABATA, Shiojiri-shi (JP); Atsushi OSHIMA, Kanie-machi (JP); Hiroyuki YOSHINO, Suwa-shi (JP); Atsuya HIRABAYASHI, Chino-shi (JP)

(73) Assignee: SEIKO EPSON CORPORATION, Tokyo (JP)

(21) Appl. No.: 13/959,922

(22) Filed: Aug. 6, 2013

(30) Foreign Application Priority Data
Aug. 31, 2012 (JP) 2012-191468

(51) Int. Cl. H02J 7/00

(52) U.S. Cl. CPC H02J 7/0052; H02J 7/0042
USPC 320/107

(57) ABSTRACT

A power generator includes a deforming unit that deforms a piezoelectric member, a pair of electrodes provided on the piezoelectric member, an inductor provided between the pair of electrodes and forming a resonator circuit with a capacity component of the piezoelectric member, a first switch connected in series with respect to the inductor, a unit that detects times when a deformation direction of the deforming unit is switched, a full-wave rectifier circuit that rectifies a current output from the pair of electrodes, an electrical storage device connected to the full-wave rectifier circuit and charging a current supplied from the full-wave rectifier circuit, a second switch connected between one of the pair of electrodes and the electrical storage device, and a control circuit that operates the first switch and the second switch.

### BACKGROUND

1. Technical Field

The present invention relates to a power generator, a secondary cell, an electronic apparatus, and a transporter.

2. Related Art

When piezoelectric materials including lead zirconate titanate (PZT), quartz (SiO₂), and zinc oxide (ZnO) are subjected to external force and deformed, electric polarization is induced within the materials and positive and negative electric charge appears on the surfaces. The phenomenon is called piezoelectric effect. Using the property of the piezoelectric material, a power generation method of vibrating a cantilever so that load may repeatedly act on the piezoelectric material and extracting the electric charge generated on the surface of the piezoelectric material as a current has been proposed.

For example, a metal cantilever with a weight and a thin plate of a piezoelectric material attached to its end is vibrated and positive and negative electric charge alternately generated in the piezoelectric material with the vibration is extracted, and thereby, an alternating current is generated. Further, a technology of rectifying the alternating current using a diode, then, accumulating it in a capacitor, and extracting it as power has been proposed (for example, see Patent Document 1 (JP-A-7-107752)). Furthermore, a technology of obtaining a direct current without generation of voltage loss in a diode by closing a contact point only while positive electric charge is generated in the piezoelectric material has been proposed (for example, see Patent Document 2 (JP-A-2005-312269)). A power generator may be downsized using these technologies. Accordingly, for example, application of incorporation of the power generator into a small electronic part in place of a battery or the like is expected.

However, in the proposed power generators in related art, there has been a problem that the obtained voltage is restricted up to a voltage generated by electric polarization of the piezoelectric material. Accordingly, in most cases, there has been an issue that a separate booster circuit is necessary and sufficient downsizing of the power generator is difficult. Further, to drive the booster circuit, power to drive the booster circuit is necessary, however, there has been an issue that boost operation becomes difficult when electrical energy of an electrical storage device is lower. In order to solve the issues, there is a method of providing a full-wave rectifier circuit or a voltage doubler rectifier circuit in parallel to the booster circuit, however, there has been an accompanying issue of upsizing of the power generator.

### SUMMARY

An advantage of some aspects of the invention is to solve at least a part of the problems described above and the invention can be implemented as the following embodiments or application examples.

### Application Example 1

This application example is directed to a power generator that generates power using power generated in a piezoelectric member when the piezoelectric member is deformed, including a deforming unit that repeatedly deforms the piezoelectric member, a pair of electrodes provided on the piezoelectric member, an inductor provided between the pair of electrodes and forming a resonator circuit with a capacity component of the piezoelectric member, a first switch connected in series with respect to the inductor, a unit that detects times when a deformation direction of the deforming unit is switched, a full-wave rectifier circuit that rectifies a current output from the pair of electrodes, an electrical storage device connected to the full-wave rectifier circuit and charging the current supplied from the full-wave rectifier circuit, a second switch connected between one of the pair of electrodes and the electrical storage device, and a control circuit that operates the first switch and the second switch.

According to the configuration, the piezoelectric member is repeatedly deformed by switching the deformation direction in response to external force, and thereby, positive and negative electric charge is generated by the piezoelectric effect in the piezoelectric member. When the first switch is short-circuited and the piezoelectric member is connected to the inductor, the piezoelectric member may be regarded as a capacitor in an electric circuit, and a resonator circuit is formed by connection to the inductor. Then, the electric charge generated in the piezoelectric member flows into the inductor. The piezoelectric member and the inductor form the resonator circuit, and the current flowing into the inductor overshoots and flows into the piezoelectric member from the opposite terminal. Thereby, the arrangement of the positive and negative electric charge generated within the piezoelectric member may be inversed before connection to the inductor.

Further, from the state, in turn, the piezoelectric member is deformed in the opposite direction, and the electric charge generated by the piezoelectric effect is accumulated in addition to the electric charge inverted and accumulated. As a result, the electric charge generated by repeated deformation of the piezoelectric member may be accumulated within the piezoelectric member. Furthermore, the voltage between terminals also increases by the amount of electric charge accumulated within the piezoelectric member, and thus, even if a booster circuit is not separately prepared, a higher voltage than the voltage generated by electric polarization of the piezoelectric material may be generated. As a result, the small and highly-efficient power generator may be obtained.

Here, to perform the boost operation, it is necessary to actively control the first switch that connects/opens the piezoelectric member and the inductor. That is, if the voltage provided to the control circuit is once below the lower limit voltage necessary for driving the first switch, it becomes impossible to actively control the first switch, and rectification is performed by the full-wave rectifier circuit for charging without the above described boost operation.

In the case where rectification is performed by the full-wave rectifier circuit for charging, it is difficult to supply the voltage equal to or more than the lower limit voltage necessary for driving the first switch to the control circuit because the voltage that may be charged in the electrical storage device is low. Accordingly, in this case, the control circuit short-circuits the second switch and switches to the voltage doubler rectifier circuit using the capacity component of the piezoelectric member. Thereby, the voltage nearly double that of the full-wave rectifier circuit may be charged in the electrical storage device, and the voltage applied to the control circuit exceeds the lower limit voltage necessary for driving the first switch. Therefore, self-resetting to the boost operation may be performed. Further, the voltage doubler rectification is performed using the capacity component of the piezoelectric member, and thereby, the small and low-cost power generator may be provided without the need of extra parts.

### Application Example 2

This application example is directed to the power generator according to the application example described above, wherein the control circuit disconnects the second switch and short-circuits the first switch when a voltage charged in the electrical storage device reaches a voltage that can drive the first switch.

According to the configuration, when the voltage charged in the electrical storage device reaches the voltage that can drive the first switch, the second switch is disconnected and the first switch is short-circuited, and thereby, the voltage nearly double that of the full-wave rectifier circuit may be charged in the electrical storage device. Accordingly, the voltage applied to the control circuit exceeds the lower limit voltage necessary for driving the second switch, and self-resetting to the boost operation may be performed. Further, the voltage doubler rectification is performed using the capacity component of the piezoelectric member, and thereby, the small and low-cost power generator may be provided without the need of extra parts.

### Application Example 3

This application example is directed to the power generator according to the application example described above, wherein the control circuit performs control of disconnecting the second switch and short-circuiting the first switch at the time when the deformation direction of the deforming unit is switched and, after a lapse of a time corresponding to a half-cycle of a resonance cycle of the resonator circuit, disconnecting the first switch when a voltage charged in the electrical storage device reaches a voltage that can drive the first switch and the second switch.

According to the configuration, when the first switch is operated and the boost operation is performed, the second switch is disconnected and the circuit is operated as the full-wave rectifier circuit, and thereby, the boost operation may be efficiently performed. Further, the amount of generated electric charge is larger as the amount of deformation of the piezoelectric member is larger, and thus, when the electric charge accumulated in the piezoelectric member is the maximum, the positive and negative electric charge within the piezoelectric member may be inversed by short-circuiting of the first switch when the deformation direction is switched. The time in which the first switch is short-circuited is a time taken for inversion of the electric charge of the piezoelectric member, and, if the first switch is short-circuited in the time corresponding to the half of the resonance cycle of the resonator circuit formed by the piezoelectric member and the inductor, the boost operation may be performed most efficiently.

### Application Example 4

This application example is directed to the power generator according to the application example described above, which further includes a charging condition detection unit that detects a charging condition of the electrical storage device, wherein the control circuit performs control of short-circuiting the second switch and disconnecting the first switch when the charging condition detection unit detects a condition that the electrical storage device is not charged.

According to the configuration, when the boost operation is performed, if the charging condition detection unit does not detect charging, the boost operation is quitted and the second switch is connected. The state that the charging condition detection unit does not detect charging is a state in which no current flows from the piezoelectric member to the electrical storage device, and the boost operation in the state does not contribute to power generation. That is, the power necessary for the boost operation is wastefully consumed. Accordingly, if the charging condition detection unit does not detect any current, the boost operation is quitted so that the power may not be wastefully consumed. Further, if the boost operation is quitted, the generated voltage of the piezoelectric member is lower than that when the boost operation is performed because of the full-wave rectifier circuit only, and it becomes harder to flow a current from the piezoelectric member to the electrical storage device. However, if the second switch is short-circuited and the circuit is switched to the voltage doubler rectifier circuit, the output voltage of the piezoelectric member becomes larger than that of the full-wave rectifier circuit, and it is easier to supply the current to the electrical storage device. According to the configuration, the highly-efficient power generator may be provided.

### Application Example 5

This application example is directed to a secondary cell including the above described power generator.

According to the configuration, even when the output voltage of the secondary cell is lower and the control of the first switch is impossible, the voltage doubler rectification is performed. Then, after the voltage equal to or more than the lower limit voltage necessary for driving the first switch is obtained, the operation is promptly shifted to the boost operation with high power generation efficiency, and thereby, the self-resettable secondary cell with higher power generation efficiency than that of normal full-wave rectification may be provided.

### Application Example 6

This application example is directed to an electronic apparatus including the above described power generator.

According to the configuration, the electronic apparatus that may operate without replacement of a battery can be provided. Further, the secondary cell including the above described power generator may be provided in the electronic apparatus, and the electronic apparatus that may operate without replacement of the battery can be provided because the self-resettable secondary cell with higher power generation efficiency than that of normal full-wave rectification is provided.

### Application Example 7

This application example is directed to a transporter including the above described power generator.

According to the configuration, the power generator of the application example of the invention is used for the transporter such as a vehicle or an electric train, and thereby, power may be generated by vibrations with the transportation and power may be efficiently supplied to an apparatus provided in the transporter.

### BRIEF DESCRIPTION OF THE DRAWINGS

The invention will be described with reference to the accompanying drawings, wherein like numbers reference like elements.

FIG. 1 is a schematic diagram showing a structure of a power generator according to an embodiment.

FIGS. 2A and 2B are circuit diagrams of the power generator according to the embodiment.

FIGS. 3A to 3D are graphs showing an operation of the power generator in a stationary state according to the embodiment.

FIG. 4A is a circuit diagram showing current paths when a second switch is short-circuited according to the embodiment, and FIG. 4B is an equivalent circuit diagram of extraction of a part relating to the current flow paths in FIG. 4A.

FIG. 5 is a flowchart for determination whether to perform an operation in the stationary state and an operation of obtaining a starting voltage according to the embodiment.

FIG. 6 is a circuit diagram of a secondary cell according to the embodiment.

FIG. 7 is a schematic view showing a schematic structure of a pedometer as an electronic apparatus according to the embodiment.

FIG. 8 is a circuit diagram for explanation of modified example 1.

FIGS. 9A and 9B show circuit diagrams for explanation of modified example 2.

FIG. 10 is a circuit diagram for explanation of modified example 3.

FIG. 11 is a circuit diagram for explanation of modified example 4.

### DESCRIPTION OF EXEMPLARY EMBODIMENTS

### Embodiment

### Power Generator Including Configuration According to the Invention

As below, respective embodiments that embody the invention will be explained with reference to the drawings.

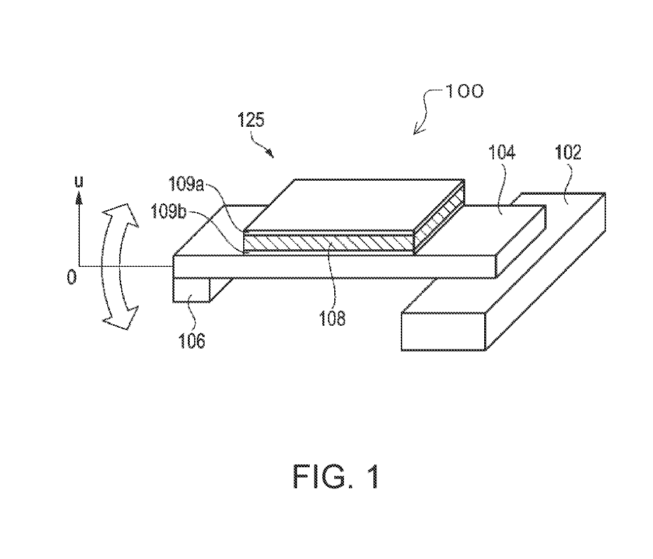

FIG. 1 is a schematic diagram showing a structure of a power generator according to the embodiment. A mechanical structure of a power generating unit 125 of a power generator 100 shown in the embodiment is a cantilever structure in which a beam 104 with a weight 106 provided on its end as a deforming unit is fixed to a support end 102 at the base end side. Further, a piezoelectric member 108 formed using a piezoelectric material such as lead zirconate titanate (PZT) is fixed and supported on the surface of the beam 104 as a supporter, and a first electrode 109a and a second electrode 109b as a pair of electrodes using conductors such as metal thin films are respectively provided on both sides of the piezoelectric member 108. Note that, in the example shown in FIG. 1, the piezoelectric member 108 is provided on the upper surface side of the beam 104, however, the piezoelectric member 108 may be provided on the lower surface side of the beam 104 or the piezoelectric materials 108 may be provided on both the upper surface side and the lower surface side of the beam 104. Note that “upper” refers to a direction as seen from the piezoelectric member 108 toward the first electrode 109a (a positive direction of u in the drawing), and “lower” refers to the opposite direction to “upper”.

The beam 104 has the base end side fixed to the support end 102 and the weight 106 provided on the end side, and thus, when a vibration or the like is applied thereto, as shown by white arrows in the drawing, the end of the beam 104 largely vibrates. As a result, the piezoelectric member 108 attached to the surface of the beam 104 is subjected to cyclic deformation due to external force, and compression force and tension force alternately act thereon. Then, the piezoelectric member 108 generates positive and negative electric charge by the piezoelectric effect, and the electric charge appears in the first electrode 109a and the second electrode 109b and is extracted as a current.

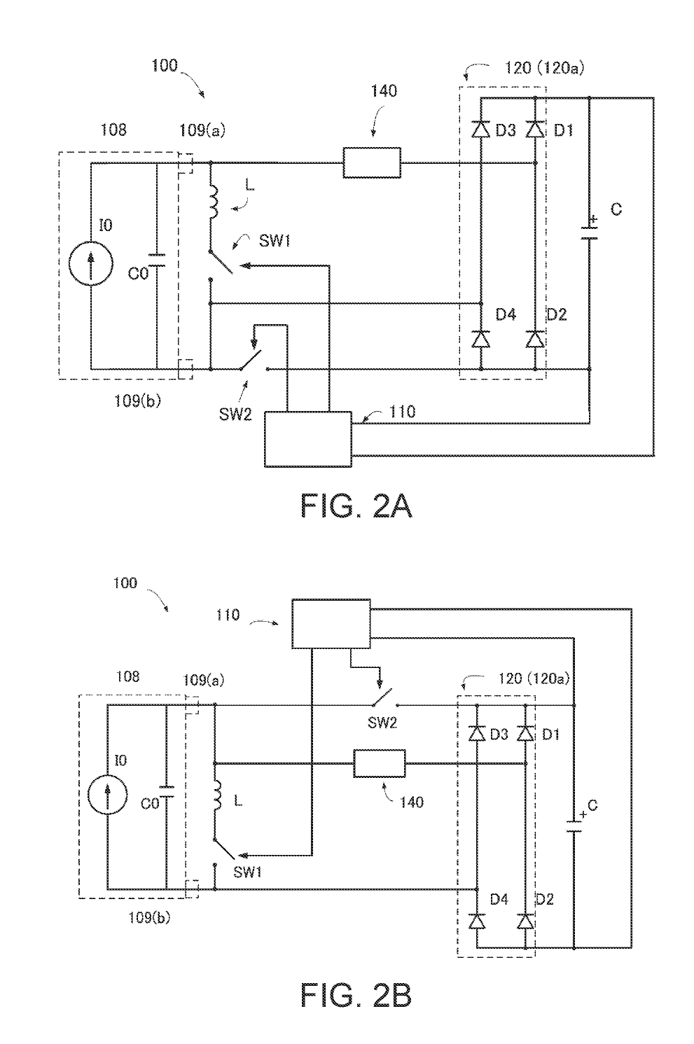

FIGS. 2A and 2B are circuit diagrams of the power generator 100 according to the embodiment. The piezoelectric member 108 is electrically expressed as a current source I0 and a capacitor C0 for accumulation of electric charge. An inductor L is connected in parallel to the piezoelectric member 108 and forms an electrical resonator circuit with the capacitor component C0 of the piezoelectric member 108. Further, a first switch SW1 for short-circuiting/opening the resonator circuit is connected in series with the inductor L. A second switch SW2 is connected to the second electrode 109b and an electrical storage device C in FIG. 2A, however, the second switch SW2 may be connected to the first electrode 109a as shown in FIG. 2B. Short-circuiting/opening of the first switch SW1 and the short-circuiting/opening of the second switch SW2 are controlled by a control circuit 110. Further, the first electrode 109a and the second electrode 109b provided on the piezoelectric member 108 are connected to a full-wave rectifier circuit 120 including four diodes D1 to D4. Though the details will be described later, to determine times to short-circuit the resonator circuit, a unit 140 configured to detect times at which the deformation directions are switched is provided. The embodiment determines the times at which the deformation direction is switched based on the current values flowing from the piezoelectric member 108 to the full-wave rectifier circuit 120, however, the times may be determined using a displacement sensor or output voltages of the piezoelectric member. Here, junction diodes are used for the diodes D1 to D4. The diodes D1 to D4 function as the full-wave rectifier circuit 120 when the second switch SW2 is opened. Further, they function as a AC to DC converter that changes an alternating current into a direct current with the electrical storage device C.

Further, the diodes D1 to D4 function as a voltage doubler rectifier circuit 120a when the second switch SW2 is short-circuited. The positive and negative electric charge generated by the piezoelectric member 108 is extracted by the first electrode 109a and the second electrode 109b as an alternating current. Then, the alternating current is converted into a pulsating current by the full-wave rectifier circuit 120 and the voltage doubler rectifier circuit 120a including the diodes D1 to D4. Then, the pulsating current is charged in the electrical storage device C.

### Operation in Stationary State

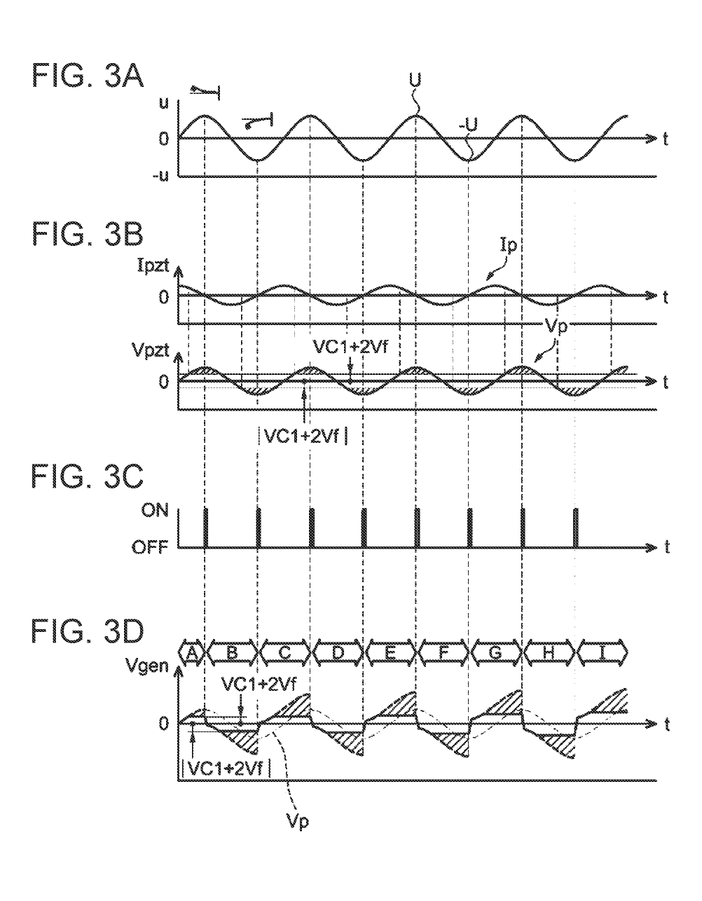

FIGS. 3A to 3D are graphs showing an operation of the power generator 100 in a stationary state according to the embodiment. Here, the stationary state refers to the case where a voltage that can control the operations of the first switch SW1 and the second switch SW2 is supplied to the control circuit 110.

FIG. 3A shows displacement of the end of the beam 104. The longitudinal axis indicates displacement u and the lateral axis indicates time t. The unit of displacement is an arbitrary unit. As shown in FIG. 3A, the displacement u of the end of the beam 104 changes with the vibration of the beam 104. Note that the positive displacement u represents a state in which the beam 104 bends upward (the upper surface side of the beam 104 is concaved) and the negative displacement (−u) represents a state in which the beam 104 bends downward (the lower surface side of the beam 104 is concaved). Further, FIG. 3B shows a current generated by the piezoelectric member 108 with the deformation of the beam 104 and an electromotive force generated inside of the piezoelectric member 108 as a result. Note that, in FIG. 3B, generation of electric charge in the piezoelectric member 108 is expressed as an amount of electric charge (i.e., current Ip) generated per unit time. Here, a current Ipzt flowing in the piezoelectric member 108 is indicated by the longitudinal axis. Further, the electromotive force generated in the piezoelectric member 108 is represented with a potential difference Vpzt generated between the first electrode 109a and the second electrode 109b as the longitudinal axis. When the operation in the stationary state is performed, the second switch SW2 is opened.

As shown in FIGS. 3A and 3B, while the displacement of the beam 104 increases, the piezoelectric member 108 generates a positive current (i.e., the current Ip takes a positive value). Accordingly, a potential difference Vp between the first electrode 109a and the second electrode 109b increases in the positive direction. If the positive potential difference Vp becomes larger than a sum of a voltage VC1 between terminals of the electrical storage device C and double a forward voltage drop Vf of the diode forming the full-wave rectifier circuit 120, i.e., VC1+2Vf, the electric charge to be subsequently generated may be extracted as a direct current and accumulated in the electrical storage device C. Further, while the displacement of the beam 104 decreases, the piezoelectric member 108 generates a negative current (i.e., the current Ip takes a negative value). Accordingly, the potential difference Vp between the first electrode 109a and the second electrode 109b increases in the negative direction. If the negative potential difference Vp becomes larger than the sum of VC1 and 2Vf of the full-wave rectifier circuit 120, the generated electric charge may be extracted as a direct current and accumulated in the electrical storage device C. This is a general power generation method. Here, a method of generating power more efficiently by controlling the first switch SW1 will be explained.

FIG. 3C is a graph showing times when the first switch SW1 is short-circuited (ON), and the switch is turned on only in the times “ON”. FIG. 3D shows voltage waveforms obtained when the first switch SW1 is short-circuited (ON) at the times shown in FIG. 3C. The longitudinal axis indicates a potential difference Vgen generated between the first electrode 109a and the second electrode 109b as a generated voltage.

The first switch SW1 is short-circuited (ON) at the times (times when the displacement of the piezoelectric member 108 becomes the local maximum or the local minimum) shown in FIG. 3C. Then, as shown in FIG. 3D, a phenomenon like that the voltage waveform between the first electrode 109a and the second electrode 109b sandwiching the piezoelectric member 108 shifts at the moment when the first switch SW1 is short-circuited occurs. For example, in a period B shown by “B” in FIG. 3D, the voltage waveform shown by a thick broken line like that the potential difference Vp shown by a thin broken line corresponding to the electromotive force of the piezoelectric member 108 shifts in the negative direction appears between the first electrode 109a and the second electrode 109b sandwiching the piezoelectric member 108.

Further, in a period C shown by “C” in FIG. 3D, the voltage waveform of a thick broken line like that the potential difference Vp corresponding to the electromotive force of the piezoelectric member 108 shifts in the positive direction appears. In the subsequent periods D, E, F, etc., similarly, the voltage waveforms of thick broken lines like that the potential difference Vp corresponding to the electromotive force of the piezoelectric member 108 shifts in the positive direction or the negative direction appear.

This is obtained using the resonance phenomenon in the resonator circuit including the inductor L and the capacity component C0 of the piezoelectric member 108. If the first switch SW1 is short-circuited (ON) at the time when the displacement of the piezoelectric member 108 becomes the local minimum (when the displacement becomes −u in FIG. 3A), the current flowing in the inductor L starts to gradually flow against the inductance of the inductor L. Then, the current flowing in the inductor L becomes the maximum when the voltage between the ends of the capacity component C0 is zero. Then, the current continues to flow because of the inductance of the inductor L, and the current becomes zero when the voltage between the ends of the capacity component C0 is inverted. Here, the first switch SW1 is opened (OFF).

Then, the piezoelectric member 108 bends in the opposite direction. That is, the current Ip takes a positive value and charges the capacity component C0 in the positive direction. As a result of the above described operation, the electric charge accumulated in the capacity component C0 is held in the inverted state, and thus, when positive electric charge is newly add, the piezoelectric member 108 takes a larger value than the value that may be obtained in the general operation.

Then, the same operation is performed when the displacement of the piezoelectric member 108 becomes the local maximum (the displacement becomes u in FIG. 3A), and thereby, in turn, a negative potential difference Vp having a larger absolute value than that of the value that may be generated in the general operation is generated. That is, the first switch SW1 is short-circuited in a period of the half cycle of the resonance cycle of the resonator circuit including the capacity component C0 and the inductor L at the times when the displacement of the piezoelectric member 108 is the local maximum or the local minimum, and thereby, power may be taken from the piezoelectric member 108 more efficiently.

In this case, the electric charge within the piezoelectric member 108 increases with deformation of the piezoelectric member 108 unless the electric charge is flown out from the piezoelectric member 108. Accordingly, the voltage between the first electrode 109a and the second electrode 109b sandwiching the piezoelectric member 108 becomes larger.

Here, in the parts in which the voltage exceeds the sum of VC1 and 2Vf (the parts shown by shading in FIG. 3D), the electric charge generated in the piezoelectric member 108 is accumulated in the electrical storage device C. Accordingly, the electric charge flows out from the piezoelectric member 108 to the electrical storage device C, and the voltage between the first electrode 109a and the second electrode 109b sandwiching the piezoelectric member 108 is clipped at the voltage of sum of the voltage between terminals of the electrical storage device C and 2Vf (VC1+2Vf). As a result, the voltage waveform of the voltage between the first electrode 109a and the second electrode 109b is the waveform shown by a thick solid line in FIG. 3D.

As clearly known from comparison between the case where the first switch SW1 remains opened as shown in FIG. 3B and the case where the first switch SW1 is short-circuited at the times when the deformation direction of the beam 104 is switched, in the power generator 100 of the embodiment, electric charge may be efficiently accumulated in the electrical storage device C by short-circuiting/opening the first switch SW1 at appropriate times.

Further, the electric charge is accumulated in the electrical storage device C and the voltage between terminals of the electrical storage device C increases, and accordingly, the amount of shift of the voltage waveform also increases. For example, in comparison between the period B in FIG. 3D (the state in which no electric charge is accumulated in the electrical storage device C) and the period H in FIG. 3D (the state in which electric charge is accumulated in the electrical storage device C), the amount of shift of the voltage waveform is larger in the period H. Similarly, in comparison between the period C and the period I in FIG. 3D, the amount of shift of the voltage waveform is larger in the period I in which the electric charge accumulated in the electrical storage device C is larger. As a result, in the power generator 100 of the embodiment, the piezoelectric member 108 is deformed, and thereby, the voltage equal to or more than the potential difference Vp generated between the first electrode 109a and the second electrode 109b may be accumulated in the electrical storage device C. Consequently, it is no longer necessary to provide a special booster circuit, and the small and highly-efficient power generator may be obtained. Hereinafter, the operation is referred to as boost operation.

If the time when the control circuit 110 turns ON a switch SW and the time when the deformation direction of the beam 104 is switched do not exactly coincide with each other, the voltage Vgen between terminals of the piezoelectric member 108 may be boosted by turning ON the switch SW with a predetermined period in the time corresponding to the half of the resonance cycle of the resonator circuit including the capacity component C0 of the piezoelectric member 108 and the inductor L.

Note that, the case where the time when the switch SW is turned ON and the time when the deformation direction of the beam 104 is switched coincide with each other is the most efficient, and the case where the time when the switch SW is turned OFF and the time when the deformation direction of the beam 104 is switched coincide with each other is the most inefficient. That is, the power generation efficiency is higher as the time when the switch SW is turned ON and the time when the deformation direction of the beam 104 is switched are as close to each other as possible.

Operation without Application of Starting Voltage

Returning to FIGS. 2A and 2B, in the case where the voltage at which the control circuit 110 may operate is supplied as the initial state through the above described boost operation, the power provided from the piezoelectric member 108 may be extracted with the higher efficiency than that in related art, however, in the case where the operation voltage (e.g., 3.3 V) is not provided to the control circuit 110 at the start time, it may be impossible to short-circuit/open the first switch SW1 or perform the boost operation. Accordingly, it is necessary to temporarily accumulate the power for starting the control circuit 110. For example, in consideration of application to a wristwatch, the piezoelectric member 108 is unable to generate power when the wristwatch is detached from the arm. Accordingly, when the energy accumulated in the electrical storage device C is exhausted, the control circuit 110 is difficult to be restarted and the power generator 100 is unable to start the boost operation. On this account, it is necessary to temporarily accumulate power required for restarting of the power generator 100.

Here, when both the second switch SW2 and the first switch SW1 are opened, the voltage generated by the piezoelectric member 108 is subjected to full-wave rectification in the full-wave rectifier circuit 120 and applied to the control circuit 110. The piezoelectric member 108 generates a voltage of about 2.5 V depending on the amplitude of the piezoelectric member 108. The voltage is referred to as VC.

When rectification is performed using the full-wave rectifier circuit 120, suppose that the forward voltage drop Vf is 0.4 V, the voltage after rectification takes a value expressed by the following equation. Note that, in the case of using the full-wave rectifier circuit 120, the current passes through the diode twice, and the voltage twice as much as Vf is lost.

VC−2×Vf=2.5 V−0.4 V×2=1.7 V

The voltage does not reach the voltage (e.g., 3.3 V) for starting the control circuit 110, and it may be impossible to start the boost operation.

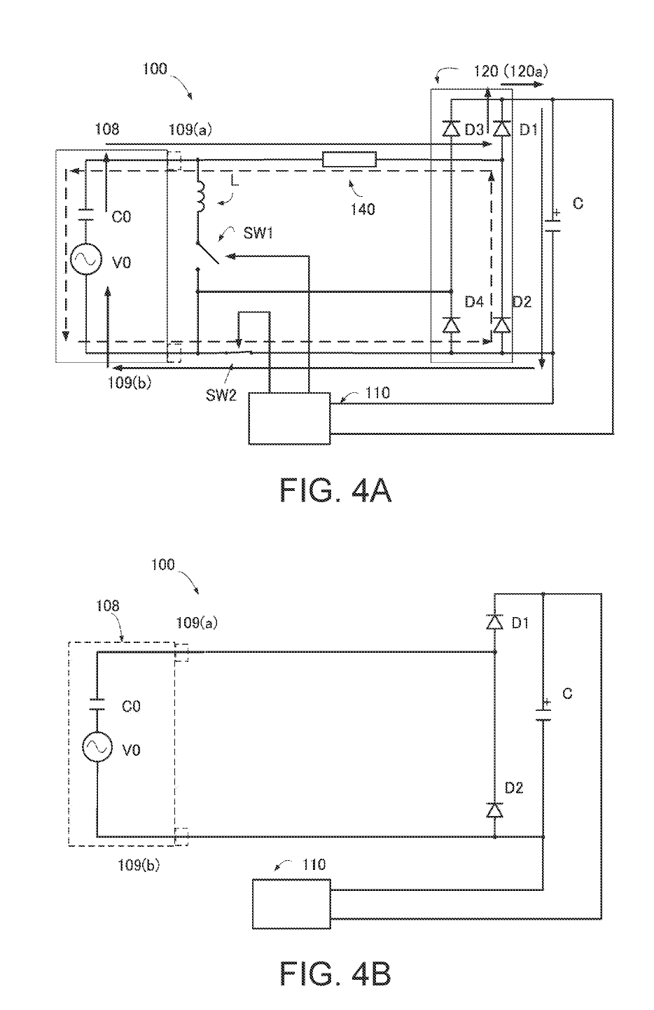

Accordingly, the second switch SW2 is short-circuited and the circuit is operated as the voltage doubler rectifier circuit 120a, and thereby, the higher voltage than the starting voltage of the control circuit 110 may be charged in the electrical storage device C. The operation of charging the higher voltage than the starting voltage in the electrical storage device C will be explained using FIG. 4A.

FIG. 4A is a circuit diagram showing current paths when the second switch SW2 is short-circuited according to the embodiment. Note that the description of the piezoelectric member 108 as the current source I0 and the capacitor C0 that accumulates electric charge is not so general illustration for the diagram of the voltage doubler rectifier circuit, and thus, the explanation will be continued with the piezoelectric member 108 as an equivalent circuit in which a voltage source V0 and the capacitor C0 that accumulates electric charge are series-connected. When the first electrode 109a side outputs a negative voltage and the second electrode 109b side outputs a positive voltage, a current flows along arrows of broken lines.

The current supplied from the voltage source V0 passes through the second electrode 109b, then, passing through the diode D2 and the first electrode 109a, charges the capacitor C0, and returns to the voltage source V0. When the first electrode 109a side outputs a positive voltage and the second electrode 109b side outputs a negative voltage, a current flows along arrows of solid lines. In this case, the voltage of the capacitor C0 is added to the voltage from the voltage source V0, and they function as one voltage source. The voltage of the capacitor C0 is obtained by subtraction of the voltage drop of the diode D2 from the voltage VC of the piezoelectric member 108. The current first passes through the capacitor C0, through the first electrode 109a, passes through the diode D1, and charges the electrical storage device C. Then, the current passes through the second electrode 109b and returns to the voltage source V0. Here, at charging of the electrical storage device C, the current is subjected to the voltage drop Vf of the diode D1, and the voltage between terminals of the electrical storage device C takes the following value.

(VC−Vf)+(VC−Vf)=(2.5−0.4)+(2.5−0.4)=4.2 V

FIG. 4B is an equivalent circuit diagram of extraction of a part relating to the current flow paths in FIG. 4A. Specifically, FIG. 4B is a circuit diagram of extraction of effectively functioning parts when the first switch SW1 is opened and the second switch SW2 is short-circuited. The circuit is a typical voltage doubler rectifier circuit and may supply a voltage nearly double VC as the voltage between the first electrode 109a and the second electrode 109b sandwiching the piezoelectric member 108 and charge the higher voltage than the starting voltage of the control circuit 110 in the electrical storage device C.

### Operation Sequence

As below, an operation sequence of the power generator 100 will be explained.

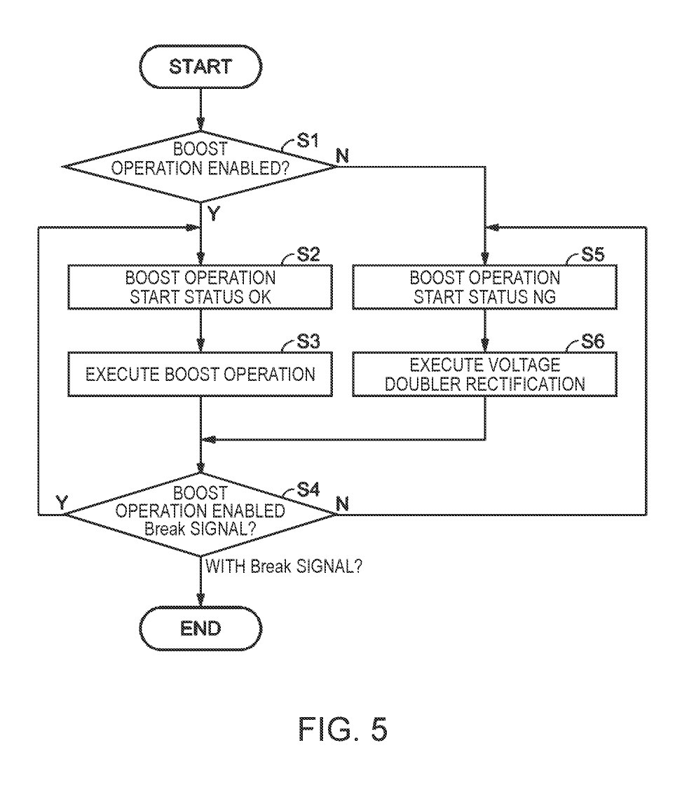

FIG. 5 is a flowchart for determination whether to perform the operation in the stationary state or the operation of obtaining the starting voltage.

First, as step S1, whether or not the boost operation is enabled is determined. Specifically, whether or not a voltage equal to or more than the minimum starting voltage of the control circuit 110 is generated is determined.

If the voltage less than the minimum starting voltage is generated (step S1: N), the process moves to step S5.

At step S5, a boost operation start status is set to NG (boost operation disabled).

Then, as step S6, voltage doubler rectification is executed.

Then, as step S4, whether or not boost operation is enabled is determined.

If the voltage equal to or more than the minimum starting voltage is generated (step S1: Y), the process returns to step S2.

If the voltage less than the minimum starting voltage is generated (step S1: N), the process returns to step S5.

If the voltage less than the minimum starting voltage is generated at START time, the above described sequence is employed.

Then, if the voltage equal to or more than the minimum starting voltage is generated at START time, the following sequence is employed.

At step S1, if the voltage equal to or more than the minimum starting voltage is generated (step S1: Y), the process moves to step S2.

At step S2, the boost operation start status is set to OK (boost operation enabled).

Then, as step S3, the boost operation is executed.

Then, as step S4, whether or not the boost operation is enabled is determined.

If the voltage equal to or more than the minimum starting voltage is generated (step S4: Y), the process returns to step S2.

If the voltage less than the minimum starting voltage is generated (step S4: N), the process returns to step S5.

In this case, the operation sequence is operated with an infinite loop. Under the condition, it may be impossible to stop the operation. Accordingly, it is preferable to provide a function of stopping power generation, after waiting for an external Break signal at step S4, if the Break signal is received (step S4: with Break signal). Note that, for example, in the case of semi-permanent power generation, input processing of the Break signal may be omitted.

Note that the boost operation start status is changed, and thereby, control of waiting for the activation start until the status becomes OK, for example, or the like may be performed on a load (not shown) connected to the power generator 100.

The above described power generator circuit exerts the following advantages.

As shown in FIGS. 3A to 3D, the resonance phenomenon in the resonator circuit including the inductor L and the capacity component C0 of the piezoelectric member 108 is used, and thereby, the larger voltage than the voltage that the piezoelectric member 108 may generate alone as described above. Accordingly, power may be extracted from the piezoelectric member 108 more efficiently, and the small and highly-efficient power generator may be obtained.

As shown in “Operation in Stationary State”, the electric charge within the piezoelectric member 108 increases with deformation of the piezoelectric member 108 unless the charge is flown out from the piezoelectric member 108. Accordingly, the voltage between terminals of the piezoelectric member 108 becomes larger. If the loss when the electric charge flows through the inductor L and the first switch SW1 or the like is not taken into account, the voltage between terminals of the piezoelectric member 108 is sequentially made larger. Therefore, with no special booster circuit, the voltage may be naturally boosted to the voltage necessary for driving of the electric load for power generation.

If the voltage between terminals of the electrical storage device C is once lower than the lower limit voltage that can drive the first switch SW1, it may be impossible to actively control the first switch SW1 or perform the above described power generation operation, however, in this case, the operation of switching the control circuit 110 from the full-wave rectifier circuit 120 to the voltage doubler rectifier circuit 120a is performed. Accordingly, a voltage near twice the voltage in the piezoelectric member 108 is provided to the control circuit 110. Through the voltage doubler rectification, the voltage between terminals of the electrical storage device C becomes higher than the lower limit voltage that can drive the first switch SW1, and the circuit is switched to the full-wave rectifier circuit 120 side and the control circuit 110 is operated in the above described rectification mechanism, and thereby, the self-resettable power generator 100 with higher power generation efficiency may be provided.

Switching from the full-wave rectifier circuit 120 to the voltage doubler rectifier circuit 120a may be performed by closing the second switch SW2, and thus, the self-resettable power generator 100 suppressed in increase in the number of parts with high power generation efficiency may be provided. In addition, if the voltage between terminals of the electrical storage device C keeps the voltage equal to or more than the lower limit voltage that can drive the first switch SW1, the full-wave rectifier circuit 120 is obtained only by opening the second switch SW2, and thus, power generation may be performed without reduction in power generation efficiency.

A normally-off switch is used as the first switch SW1 and a normally-on switch is used as the second switch SW2, and thereby, even if the voltage between terminals of the electrical storage device C does not reach the voltage that can control the operations of the first switch SW1 and the second switch SW2, the second switch SW2 is turned ON. That is, without control, the full-wave rectifier circuit 120 is switched to the voltage doubler rectifier circuit 120a, and thereby, the self-resettable power generator 100 with higher power generation efficiency may be provided.

### Secondary Cell

As below, an example of forming the secondary cell will be explained.

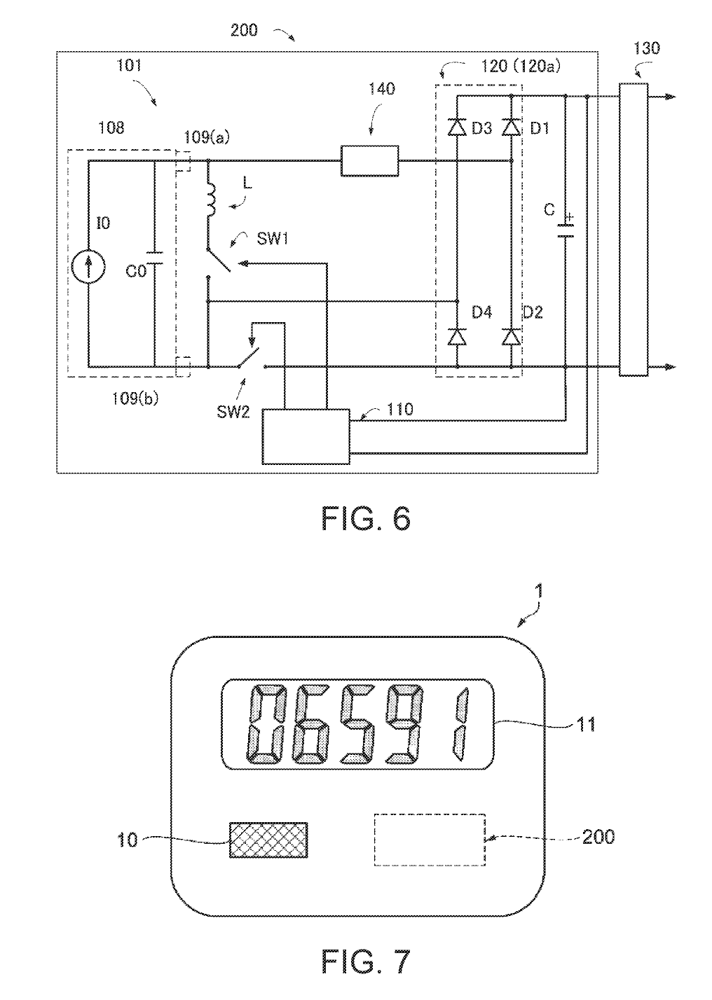

FIG. 6 is a circuit diagram of a secondary cell according to the embodiment. A secondary cell 200 includes a power generator 101 and a voltage stabilizer circuit 130. The power generator 101 has been described above, and the duplication of the explanation will be avoided.

The voltage stabilizer circuit 130 receives supply of power from the power generator 101 and supplies the power to a load (not shown). Here, the example using the power generator 101 has been explained, however, the power generator 100 may be used.

The above described secondary cell 200 exerts the following advantages.

Even when the voltage between terminals of the electrical storage device C is lower than the lower limit voltage that can drive the first switch SW1, if a vibration is applied once, the voltage doubler rectification is performed in the above described manner. Then, when the voltage reaches a voltage equal to or more than the lower limit voltage that can drive the first switch SW1, the operation is switched to the boost operation, and thereby, the voltage subjected to voltage adjustment and stabilized with respect to the load (not shown) by the voltage stabilizer circuit 130 may be efficiently provided.

### Electronic Apparatus

As below, an example of an electronic apparatus will be explained.

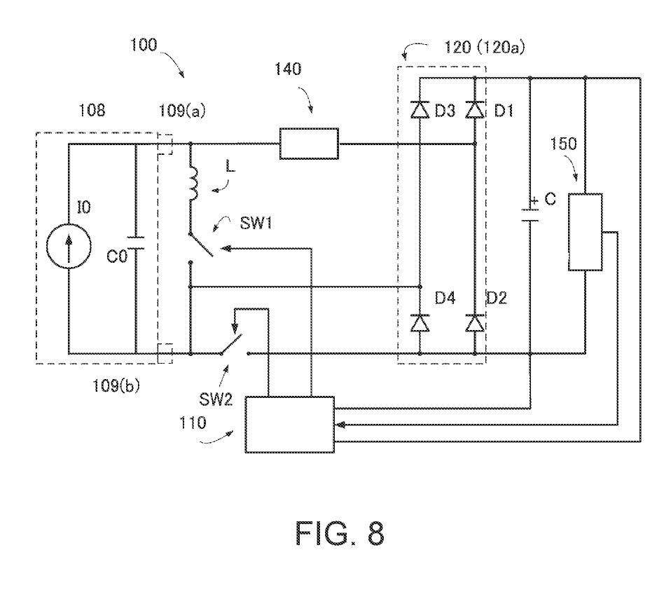

FIG. 7 is a schematic view showing a schematic structure of a pedometer as an electronic apparatus according to the embodiment. A pedometer 1 includes a reset button 10, a display part 11, and a secondary cell 200. When the pedometer 1 remains still in a long period, the voltage between terminals of the electrical storage device C (see FIG. 6) of the secondary cell 200 is below the lower limit voltage that can drive the first switch SW1.

Here, when a vibration is once applied to the pedometer 1, the secondary cell 200 performs the voltage doubler rectification as described above, the voltage between terminals of the electrical storage device C reaches the voltage equal to or more than the lower limit voltage that can drive the first switch SW1, then, the boost operation is promptly performed, and thereby, the pedometer 1 operates.

Note that, here, the pedometer 1 has been exemplified as the electronic apparatus, however, this is not limited to the pedometer, but may be applied to a wristwatch, wearable apparatus, or an electronic apparatus that is subjected to a mechanical vibration and operates, for example. Particularly, the boost operation is a rectification method with high efficiency, and may be preferably used for an electronic apparatus dealing with application having larger power consumption intended for wireless operation.

The above described electronic apparatus exerts the following advantages. The secondary cell 200 performs the boost operation with high power generation efficiency, and thus, may provide power with high efficiency even by a small vibration. Accordingly, a calculation function requiring power such as calorie calculation may be added as a function of the pedometer 1, for example.

Further, the power generator of the embodiment of the invention generates power in response to vibrations and transportations, and thus, if the power generator is provided, for example, on bridges, buildings, or locations in which landslides are anticipated, power may be generated when a disaster such as an earthquake occurs and supplied to a network appliance such as an electronic apparatus only when necessary (when a disaster occurs).

Note that the power generator of the embodiment of the invention may be downsized and may be provided in various apparatuses including, but not limited to the electronic apparatus. For example, the power generator of the embodiment of the invention is used for a transportation means including vehicles and electric trains, and thereby, power may be generated by vibrations with the transportation and supplied to the apparatus of the transportation means with high efficiency.

Note that the invention is not limited to the above described embodiment, however, various changes, improvements, etc. may be made to the above described embodiment. Modified examples will be shown as below. Note that, for explanation of the modified examples, the same configurations as those of the above described embodiment have the same signs and their explanation will be omitted.

### Modified Example 1

FIG. 8 is a circuit diagram for explanation of the modified example. As shown in FIG. 8, an electrical storage voltage detection circuit 150 that detects a voltage between terminals of the electrical storage device may be provided between terminals of the electrical storage device C. The control circuit 110 performs control of performing the boost operation when the voltage between terminals of the electrical storage device C is higher than the lower limit voltage that can drive the first switch SW1, and opening the first switch SW1 and short-circuiting the second switch SW2 when the voltage is lower than the lower limit voltage that can drive the first switch SW1. Thereby, switching between the boost operation and the voltage doubler rectification is efficiently performed and the power generator with high power generation efficiency may be provided.

### Modified Example 2

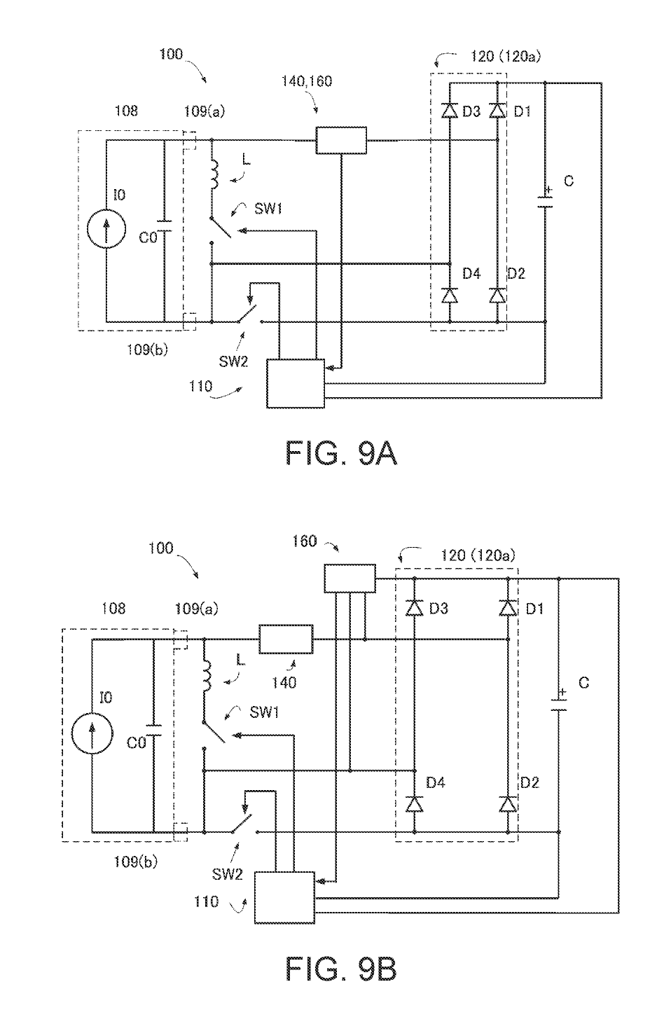

FIGS. 9A and 9B show circuit diagrams for explanation of the modified example. A charging condition detection unit 160 for determining whether or not a current flows from the piezoelectric member 108 to the full-wave rectifier circuit 120 is provided, and, if the charging condition detection unit 160 does not detect charging when the boost operation is performed, the control circuit 110 may stop the boost operation and short-circuit the second switch SW2. The state in which the charging condition detection unit 160 does not detect charging is a state in which no current flows from the piezoelectric member 108 to the electrical storage device C and the boost operation does not contribute to power generation. At this time, the boost operation is quitted, and thereby, the power for driving the first switch SW1 may not be consumed wastefully.

Further, when the boost operation is quitted, normally, only the full-wave rectifier circuit 120 functions. Therefore, the generated voltage of the piezoelectric member 108 becomes lower than that when the boost operation is performed, and it becomes harder to flow a current from the piezoelectric member 108 to the electrical storage device C. However, when the second switch SW2 is short-circuited and the circuit is switched to the voltage doubler rectifier circuit 120a, the output voltage of the piezoelectric member 108 becomes larger than that of the full-wave rectifier circuit 120, and it is easier to supply the current to the electrical storage device C.

According to the configuration, the power generator with high power generation efficiency may be provided.

Note that the charging condition detection unit 160 may detect the current actually flowing from the piezoelectric member 108 to the full-wave rectifier circuit 120. In this case, as shown in FIG. 9A, the unit 140 configured to detect times at which deformation directions are switched in FIG. 2A may substitute the unit. In addition, as shown in FIG. 9B, the charging condition detection unit 160 may measure the voltages between anodes and cathodes of the diodes D1, D3 of the full-wave rectifier circuit 120 and detect whether or not there is charging. In this case, if the voltage is higher at the anode side than that at the cathode side, a charging condition is determined such that a current flows from the piezoelectric member 108 to the electrical storage device C. The method is easily performed because it does not require measurement of a weak current flowing from the piezoelectric member.

### Modified Example 3

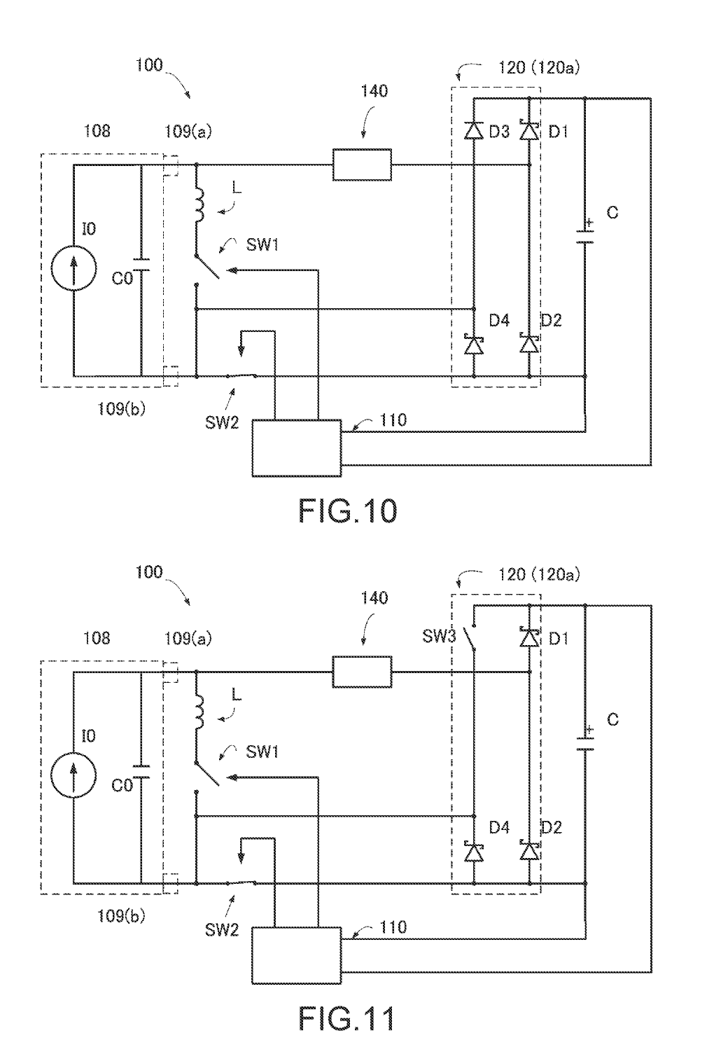

The explanation will be made using FIGS. 4A and 10.

FIG. 10 is a circuit diagram for explanation of the modified example. In the modified examples 3, 4, the full-wave rectifier circuit 120 is formed using a schottky barrier diode. The schottky barrier diode has a property that its forward voltage drop is lower than that of a junction diode. Accordingly, a voltage higher by an amount of voltage corresponding to the difference in forward voltage drop between the junction diode and the schottky barrier diode may be supplied to the electrical storage device. However, there is a disadvantage that there is a large amount of backward leak current. When the circuit operates as the above described voltage doubler rectifier circuit 120a, the diode D3 and the diode D4 do not contribute to rectification (but there is no actual harm because the anode and the cathode are short-circuited with respect to the diode D4). The diode D3 that does not contribute to voltage doubler rectification leaks a current and causes reduction in power generation efficiency. In this case, a joint diode is used only for the diode D3, and thereby, leak may be suppressed and the voltage may reach the voltage at which the control circuit 110 may promptly operate. FIG. 10 shows the circuit diagram when the diode D3 is replaced by the junction diode.

### Modified Example 4

The explanation will be made using FIGS. 4A and 11.

FIG. 11 is a circuit diagram for explanation of the modified example. When the circuit operates as the above described voltage doubler rectifier circuit 120a, the diode D3 and the diode D4 do not contribute to rectification (but there is no actual harm because the anode and the cathode are short-circuited with respect to the diode D4). That is, when voltage doubler rectification is performed, ideally, absence of them is advantageous. Accordingly, a normally-off MOS switch or the like is used in place of the diode 3, and thereby, leak may be suppressed and the voltage may reach the voltage at which the control circuit 110 may promptly operate. Note that, after the control circuit 110 once operates, the MOS switch contributes to synchronously rectification, and thereby, full-wave rectification may be performed with suppressed forward voltage loss. FIG. 11 shows the circuit diagram when the diode D3 is replaced by a switch SW3.

This application claims priority to Japanese Patent Application No. 2012-191468 filed on Aug. 31, 2012, the entirety of which is hereby incorporated by reference.

What is claimed is:

1. A power generator that generates power using power generated in a piezoelectric member when the piezoelectric member is deformed, comprising:
a deforming unit that repeatedly deforms the piezoelectric member;
a pair of electrodes provided on the piezoelectric member;
an inductor provided between the pair of electrodes and forming a resonator circuit with a capacity component of the piezoelectric member;
a first switch connected in series with respect to the inductor;
a unit that detects times when a deformation direction of the deforming unit is switched;
a full-wave rectifier circuit that rectifies a current output from the pair of electrodes;
an electrical storage device connected to the full-wave rectifier circuit and charging the current supplied from the full-wave rectifier circuit;
a second switch connected between one of the pair of electrodes and the electrical storage device; and
a control circuit that operates the first switch and the second switch.

2. The power generator according to claim 1, wherein the control circuit disconnects the second switch and short-circuits the first switch when a voltage charged in the electrical storage device reaches a voltage that can drive the first switch.

3. The power generator according to claim 1, wherein the control circuit performs control of disconnecting the second switch, and short-circuiting the first switch at the time when the deformation direction of the deforming unit is switched and, after a lapse of a time corresponding to a half-cycle of a resonance cycle of the resonator circuit, disconnecting the first switch when a voltage charged in the electrical storage device reaches a voltage that can drive the first switch and the second switch.

4. The power generator according to claim 1, further comprising a charging condition detection unit that detects a charging condition of the electrical storage device,
wherein the control circuit performs control of short-circuiting the second switch and disconnecting the first switch when the charging condition detection unit detects a state in which the electrical storage device is not charged.

5. A power generator that generates power using power generated in a piezoelectric member when the piezoelectric member is deformed, comprising:
a deforming unit that repeatedly deforms the piezoelectric member;
a pair of electrodes provided on the piezoelectric member;
an inductor provided between the pair of electrodes and forming a resonator circuit with a capacity component of the piezoelectric member;
a first switch series-connected to the inductor;
a unit that detects times when a deformation direction of the deforming unit is switched;
a full-wave rectifier circuit that rectifies a current output from the pair of electrodes;
an electrical storage device connected to the full-wave rectifier circuit and charging the current supplied from the full-wave rectifier circuit;
a second switch connected between one of the pair of electrodes and the electrical storage device; and
a control circuit that operates the first switch and the second switch.

6. The power generator according to claim 1, wherein the second switch is of a normally-on type.

7. The power generator according to claim 4, wherein the control circuit performs control of disconnecting the second switch, and, after a lapse of a predetermined time from short-circuiting of the first switch at a time when the deformation direction of the deforming unit is switched, disconnecting the first switch when a voltage charged in the electrical storage device reaches a voltage that can drive the first switch and the second switch.

8. A secondary cell comprising the power generator according to claim 1.

9. An electronic apparatus comprising the power generator according to claim 1.

10. A transporter comprising the power generator according to claim 1.

11. A secondary cell comprising the power generator according to claim 5.

12. An electronic apparatus comprising the power generator according to claim 5.

13. A transporter comprising the power generator according to claim 5.
